(19) United States
(12) Patent Application Publication
(10) Pub. No.: US 2002/0051961 A1
(43) Pub. Date: May 2, 2002

(54) Device, system and method for providing information

(76) Inventor: Akihiro Kawamura, Chiba-Ken (JP)

Correspondence Address: BIRCH STEWART KOLASCH & BIRCH, PO BOX 747, FALLS CHURCH, VA, 22040-0747, US

(21) Appl. No.: 09/963,391

(22) Filed: Sep. 27, 2001

(30) Foreign Application Priority Data
Sep. 29, 2000 (JP) P2000-300315

(51) Int. Cl. G06F 7/00

(52) U.S. Cl. 434/322

(57) ABSTRACT

A device, system and method for providing information on an exercise, which is surmised to be possibly overcome by a user, from among a plurality of exercises requiring the user to deal with characters within a time predetermined individually. In an information providing system 1, a storage unit 3 stores data of the number of characters contained in sentences of examination questions for an examination as an exercise 5, a measuring unit 7 measures an ability to read characters of a user 2. On the basis of a result of the measurement, a retrieval unit 9 retrieves data of the examination such that the user can read through within the time which can be allocated for reading during the predetermined examination time. A result of the retrieval is output to the display unit 13 as an output unit 11 and an examination name is presented to the user 2. The user 2 can obtain information on the examination, which is surmised to be possibly passed, from among a large number of examinations.

### BACKGROUND OF THE INVENTION

1. Field of the Invention

This invention relates to a device, system and method for providing information. More particularly, this invention pertains to an information providing device, system, and method for providing information on an exercise which can be overcome by a user, from among a plurality of exercises requiring the user to deal with characters within the time predetermined individually.

2. Description of the Prior Art

In recent years, the traditional social structure such as seniority system has been decaying whereas the new sense of value such as merit system has been rising, and our society seems to reach a turning point.

By the change of such social structure, the number of people who are interested in certifying examinations is increasing. Meanwhile, the Ministry of Labor takes measures to favor employees who satisfy requirements such as taking out unemployment insurance for more than five years, etc., and encourage them to acquire qualification by bearing a part of cost necessary for a preparation course for a certifying examination.

In such a situation where a certifying examination arouses strong interest, and acquisition of a qualification is encouraged, the number of qualifications, whether they are authorized publicly, e.g. by nation or authorized by private organizations, is anticipated to increase. There will be various kinds of qualifications having different difficulty levels.

At present, information on certifying examinations is found in books. A person who is interested in a certifying examination obtains information in a book and makes efforts to pass the certifying examination which should be overcome to acquire a qualification.

A result of a certifying examination depends on whether an examinee can obtain a passing score by answering examination questions within a predetermined examination time of the examination date. If an examinee takes an examination without sufficient basic ability, e.g. ability to read characters, he/she will fail irrelevant to his/her knowledge enough to pass the examination.

In short, it is impossible for an examinee to pass a certifying examination, if the basic ability of the examinee on the examination date does not correspond with that required by the examination. Such examinee needs to change the target of certifying examination to another he/she wishes to qualify, or to improve his/her basic ability so that it corresponds with that required by the initially desired certifying examination.

Brief information on certifying examinations is found in books, however, specific information on a certifying examination which will possibly be overcome by respective individuals having the respective basic ability, is not presented.

The viewpoint that the number of characters which should be dealt with within the predetermined time for an exercise is concerned, may be applied not only to the estimation of the possibility of passing examinations such as a certifying examination or an entrance examination, but also to the estimation of the possibility whether textbooks of a preparation course for a certifying examination will be studied completely by the examination date reckoned from the present, or whether a book lent out by a library having a returning limit will be read through within the time limit.

### SUMMARY OF THE INVENTION

Therefore, it is an object of the present invention to provide an information providing device, system and method for providing information on an exercise which can be overcome by a user, from among a plurality of exercises requiring the user to deal with characters within a time predetermined individually.

To attain the above object and according to one aspect of the present invention, an information providing device for providing information on an exercise which is surmised to be possibly overcome by a user, from among a plurality of exercises requiring the user to deal with characters within a time predetermined individually, comprises: a storage means for storing data on the number of characters which is required in each of the exercises; a measuring means for measuring the predetermined ability to deal with characters of the user; a retrieval means for retrieving the data which can be dealt with by the basic ability measured by the measuring means within the predetermined time, from among the data stored in the storage means; and an output means for outputting information on the exercise corresponding to the data retrieved by the retrieval means.

Since data on the number of characters which is required in respective exercise are stored, and the data which can be dealt with by the user within the predetermined time is retrieved and output from among the stored data, the user is presented information on the exercise which seems to correspond with his/her ability based on the output result.

In the present invention, the output means may be a display means whereby, the information is presented visually to the user by the display means such as a computer display.

In the present invention, the basic ability may be an ability to read characters. The information on an exercise as to ability to read is output and presented to the user, from among the basic abilities such as an ability to read, write, listen, speak, and memorize which are necessary for communication.

In the present invention, the exercise may be an examination held within a examination time. The information on the examination which seems to correspond with the user's ability, from among the various kinds of examination, e.g., a certifying examination and an entrance examination which may affect the user's future materially is presented.

In the present invention, the exercise may be a preparation course for an examination which is held no later than the examination date. The information on the preparation course for the examination which seems to correspond with the user's ability, from among the preparation course for the examination which may affect the user's future materially, is presented.

In the present invention, the exercise may be a book having a returning limit lent by a library. Such a case where a user borrows a book from a library which can not be read through by the returning limit and returns it without reading through, or a case where a user keeps an overdue book to read through, may be avoided.

In the present invention, the information providing device may further comprise a training means for training the predetermined basic ability to deal with characters of the user: wherein the measuring means measures the predetermined ability to deal with characters of the user after the training by the training means; wherein the retrieval means retrieves data which can be dealt with by the basic ability after the training measured by the measuring means within the predetermined time from among the data stored in the storage means; and wherein the output means outputs information on the exercise corresponding to the data retrieved after the training. The basic ability is trained while applying loads; the improved basic ability is measured after the training; and data which can be dealt with within the predetermined time by the ability of the user after the training, is retrieved and output, from among the stored data; and on the basis of the output result, information on an exercise, which seems to correspond with the user's ability improved by the training, is presented to the user.

According to another aspect of the present invention, an information providing system comprises: an information communication network; an information providing device for providing information on an exercise which is surmised to be possibly overcome by a user, from among a plurality of exercises requiring the user to deal with characters within a time predetermined individually, the information providing device being connected to the information communication network; and a terminal connected to the information network for outputting the information on exercise; wherein the information providing device comprises: a storage means for storing data on the number of characters which is required in each of the exercises; a measuring means for measuring the predetermined ability to deal with characters of the user; a retrieval means for retrieving the data which can be dealt with by the basic ability measured by the measuring means within the predetermined time, from among the data stored in the storage means; and an output means for outputting information on the exercise corresponding to the data retrieved by the retrieval means. By utilizing the information communication network, information on the exercise which is really necessary for the respective user is presented, from among a number of exercises having different varieties.

According to another aspect of the present invention, an information providing method for providing information on an exercise which is surmised to be possibly overcome by a user, from among a plurality of exercises requiring the user to deal with characters within the a predetermined individually, comprises the steps of: storing data on the number of characters which is required in each of the exercises; measuring the predetermined ability to deal with characters of the user; retrieving the data which can be dealt with by the measured basic ability within predetermined time, from among the stored data; outputting information on the exercise corresponding to the retrieved data.

In the present invention, the information providing method may further comprise the steps of: training the predetermined ability to deal with characters of the user; measuring the predetermined ability to deal with characters of the user measured after the training; retrieving the data which can be dealt with by the measured basic ability within predetermined time, from among the stored data; and outputting information on the exercise corresponding to the retrieved data.

### BRIEF DESCRIPTION OF THE DRAWINGS

The invention will be explained in more detail in conjunction with appended drawings, wherein:

FIG. 1 is a schematic diagram showing an information providing device according to an embodiment of the present invention;

FIG. 2 is an explanatory view illustrating an example that the exercise is an examination which is held within a predetermined examination time;

FIG. 3 is an explanatory view illustrating an example that the exercise is a preparation course for a certifying examination which can be taken by a user from the present until the examination date;

FIG. 4 is an explanatory view illustrating an example that the exercise is a book having a returning limit lent by a library;

FIG. 5 is a flow chart illustrating steps of operation in the information providing device shown in FIG. 1;

FIG. 6 is a view showing an example of data on the number of characters which are stored in the storage unit shown in FIG. 1;

FIG. 7 is a view showing an example of a screen for measuring an ability to read characters of a user;

FIG. 8 is a view showing an example of a screen for displaying a measured result of an ability to read characters of a user;

FIG. 9 is a schematic diagram showing an information providing device according to another embodiment of the present invention;

FIG. 10 is a flow chard illustrating steps of operation in the information providing device shown in FIG. 9; and

FIG. 11 is a schematic diagram showing an information providing system according to an embodiment of the present invention.

### DETAILED DESCRIPTION OF THE PREFERRED EMBODIMENTS

Referring to drawings, preferred embodiments of the present invention will be described below.

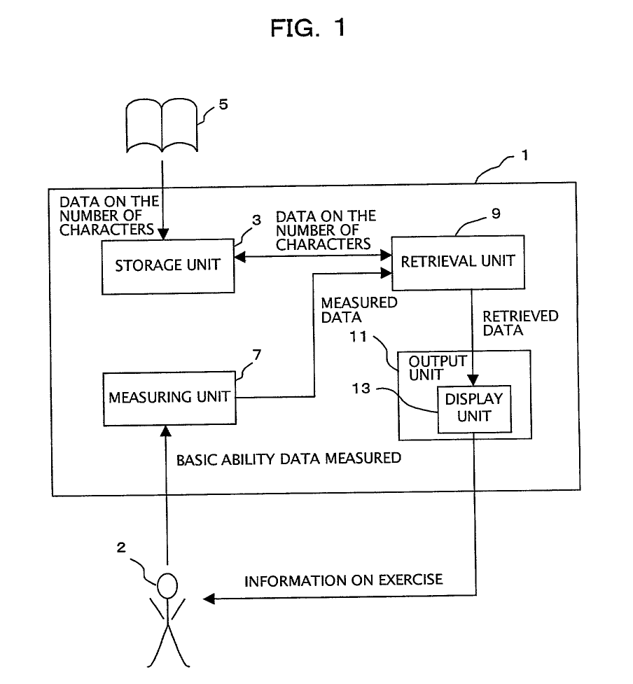

FIG. 1 is a schematic diagram showing an information providing device according to an embodiment of the present invention.

An information providing device 1 provides information on an exercise, which is surmised to be possibly overcome by a user 2, from among a plurality of exercises requiring the user 2 to deal with characters within the time predetermined individually, and is provided with a storage unit 3, a measuring unit 7, a retrieval unit 9, and an output unit 11.

The storage unit 3 stores data on the number of characters which is required in each exercise 5. The measuring unit 7 measures an ability to deal with characters as the predetermined basic ability, specifically, an ability to read of the user 2 for example. The retrieval unit 9 retrieves the data which can be dealt with within the predetermined time by the basic ability measured by the measuring unit 7, from among the data stored in the storage unit 3. The output unit 11 outputs the information on the exercise corresponding to the retrieved data to the user 2. In this embodiment, such information is output on a screen of a display unit 13 such as a computer display, however, it may be output by a printer.

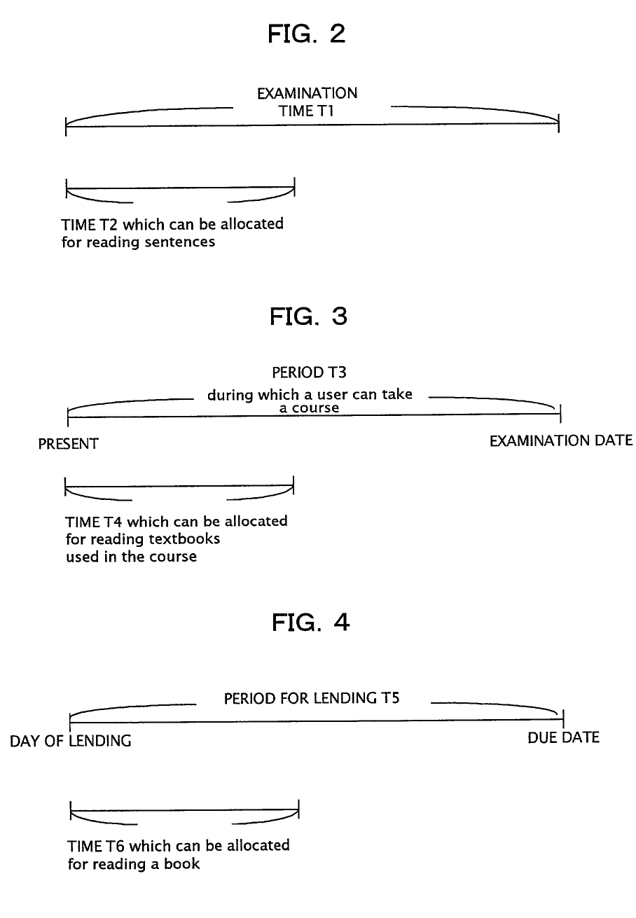

FIG. 2 is an explanatory view illustrating an example that the exercise is an examination which is held within a predetermined examination time.

Examinations such as a certifying examination and an entrance examination are usually held within the predetermined examination time shown as an examination time T1 in FIG. 2. At present, examinations generally require an examinee to read sentences of examination questions containing characters and answer them in writing.

Focusing on an ability to read characters as a basic ability for example, a time T2 which can be allocated for reading sentences of examination questions during the examination time T1, is limited to some extent. This is because, a time for thinking, a time for writing answers, etc. are necessary, in addition to the time for reading. In other words, in the case of an examination as an exercise, the time T2 is the time necessary for work by using an ability to read as a basic ability to deal with characters. It is therefore one of the targets for the examinee to read through the sentences of examination questions within the time T2 on the examination date so as to overcome the exercise, i.e., to pass the examination.

In the above description, reference has been made to an ability to read as an ability to deal with characters. In addition to an ability to read, an ability to write, an ability to grasp and memorize the vocabulary in the sentences of examination questions, and further a combination of these abilities to deal with characters, may also be applicable. In accordance with the characteristics of an actual examination, a combination of such abilities may preferably be set as the ability to deal with characters, whereas the examination time T1 would be used as the predetermined period within which the characters need to be dealt with.

Other than the examination in which the examinee reads sentences of examination questions containing characters and answers them in writing, there are various kind of examinations. If an examination requires an examinee to grasp the examination questions by listening such as English proficiency test, an ability to listen may be set as a basic ability. If an examination is an interview, an ability to speak may be set as a basic ability.

Examinations may comprise one subject but in many cases a plurality of subjects. Therefore, a combination of the abilities to deal with characters in respective subjects may be set as an ability to deal with characters in the examination whereas, the combined examination time T1 may be set as the predetermined time. Further, a possibility of passing the examination may preferably be surmised with respect to all subjects so that the user can recognize his/her insufficient ability to overcome the exercise, i.e., to pass the examination.

The information providing device 1 provides information on the exercise such as name of certifying examination which is surmised to be possibly passed with the current ability of the user 2, from among a number of exercises as to examinations.

The number of characters contained in the exercise may be set by utilizing the numbers of characters contained in the sentences of examination questions and sample answers of past examinations, or the numbers of characters contained in the sentences of examination questions and sample answers of mock examinations assuming the actual examination.

FIG. 3 is an explanatory view illustrating an example that the exercise is a preparation course for a certifying examination which will be held from the present until the examination date.

Hereinafter, a preparation course for an examination as one of the preparations to pass the examination is described as an example of the exercise.

With regard to a preparation course for an examination, a time T4 which can be allocated for reading textbooks used in the course excluding the time necessary for daily life during the period of T3 (during which a user can take a course), is limited to some extent, as is similar to the case where an exercise is an actual examination held on a certain examination date.

The information providing device 1 provides information on names of the courses, which are surmised to be studied and completed by the current ability of the user by the examination date, from among a number of exercises as to the preparation course for examination.

In the case of the preparation course for the examination, the number of characters contained in the textbook used in the course and the number of characters contained in sentences of sample answers may be utilized as data.

An exercise book available at stores may be utilized as a preparation for examinations, as is similar to the case of the preparation course for the examination, the information on the name of exercise books which are surmised to be studied and completed by the examination date may be provided, by calculating the time which can be allocated for reading the set of questions.

FIG. 4 is an explanatory view illustrating an example that an exercise is a book having a returning limit lent by a library.

Various libraries such as a school library or the National Diet Library lend out a book which has a returning limit. In such a case, a time T6 which can be allocated for reading the book during the period of lending T5, is limited to some extent, as is similar to the case of an examination or a preparation course for examination.

The information providing device 1 provides information on the name of the book which is surmised to be read through by the current ability of the user by the returning limit. Consequently, a library is utilized in a manner that a user can finish reading a book and return it within a returning limit, thereby enabling the easy management of the period of lending by the library.

Since the exercise in this case is reading books, it is sufficient to set an ability to read characters as a basic ability. The kind of the characters is not limited, and the books may be written in foreign languages or in Japanese.

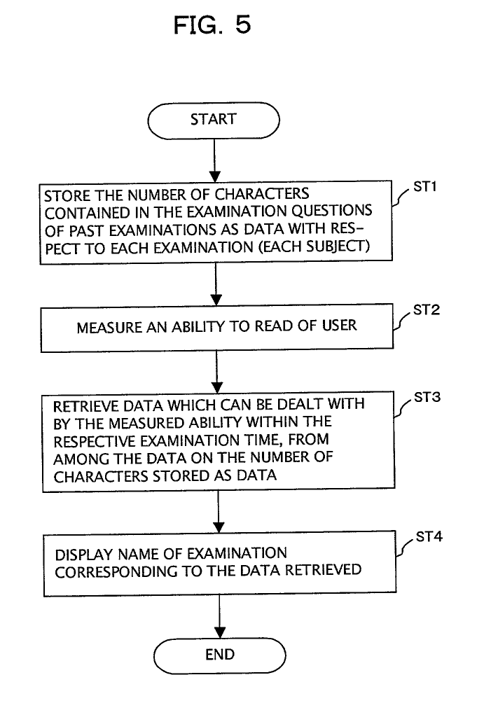

FIG. 5 is a flow chart illustrating steps of operation in the information providing device shown in FIG. 1.

Similar to the description referring to FIG. 2, operation in the information providing device 1 shown in FIG. 1 will be described below when the exercise is an examination and an ability to read is set as a basic ability.

At step ST1, the number of characters contained in the examination questions of the past examinations is stored as data with respect to each examination (each subject). The data on the number of characters is stored in the storage unit 3.

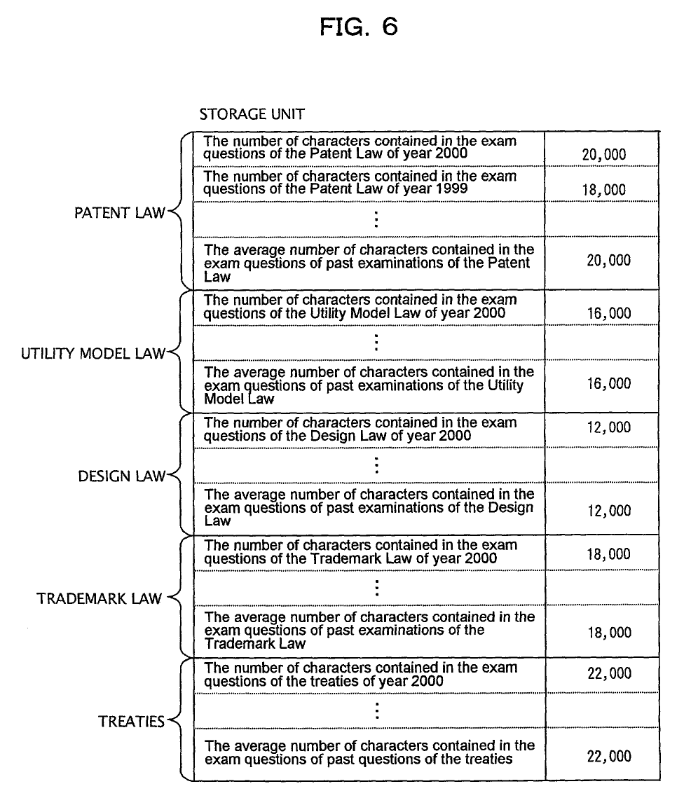

In the case of a multiple-choice examination of patent attorney examination, for example, data on the number of characters as to five compulsory subjects are stored as shown in FIG. 6. The number of characters contained in the examination questions with respect to each year and, the average number of characters contained in the examination questions of the past examinations, are stored as data. Specifically, FIG. 6 shows that the number of characters contained in the examination questions of the Patent Law in the year 2000 is 20,000 characters; the number of characters included in the examination questions of the Patent Law in the year 1999 is 18,000 characters, etc.

Similarly, data on the number of characters contained in the examination questions of Utility Model Law, Design Law, Trademark Law, and treaties, are stored as data.

At step T2, the ability to read characters of a user is measured by the measuring method described hereinafter.

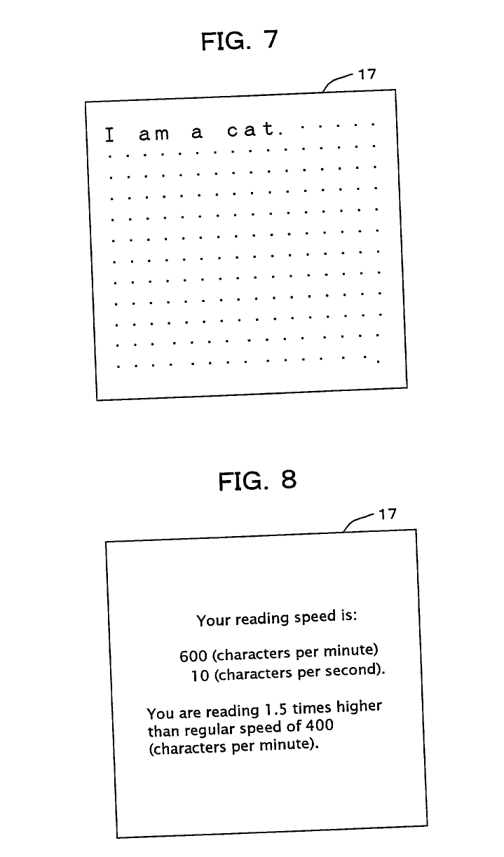

First, the following message is displayed on a screen 17 of the measuring unit 7: “Please press the space key and start reading the sentences displayed. When finished, please press the space key again.” When the user presses the space key in accordance with the instructions, sentences such as “I am a cat. . . . ” is displayed on the screen 17 as shown in FIG. 7. When the space key is pressed again after the completion of reading, the screen 17 displays a measurement result describing the user's current ability to read characters as shown in FIG. 8.

At step T3, the data which can be read through within the time T2 of respective examination by the measured ability, is retrieved from among the stored data on the number of characters. The retrieval unit 9 retrieves data on the number of characters stored in the storage unit 3 based on the measured data output from measuring unit 7.

Referring to FIG. 8, description will be made of a multiple-choice examination of patent attorney examination by way of example. The reading speed of the user is 600 characters per minute, so that 108,000[=3(hours)×60(minutes)×600(characters per minute)] is derived as the maximum number of characters read through within the examination time of three hours. Since the total number of characters contained in the sentences of the past examinations as to five compulsory subjects is 88,000 on the average, the user is anticipated to read through the sentences of the examination questions within the examination time. Since the user can read through sentences of examination question while grasping the meanings thereof within the examination time, it is possible that he/she will pass the examination if efforts for acquiring knowledge necessary for answering examination questions are made.

On the other hand, assuming that a person whose reading speed is half of 400 characters per minute shown as the reference speed shown in FIG. 8 takes a multiple-choice examination of patent attorney examination, his/her reading speed is 200 characters per minute, so that 36,000[=3(hours)×60(minutes)×200(characters per minute)] is derived as the maximum number of characters read through within the examination time of three hours. since the person cannot read through sentences of examination question within the examination time, it is hardly possible that he/she will pass the examination.

At step ST4, the display unit 13 as the output unit 11 outputs and displays information on the exercise corresponding to the retrieved data, e.g., information on the name of certifying examination and the like.

Thus, the name of certifying examination and the like corresponding with the basic ability of the user 2 based on the output result is presented, the user 2 can make efforts to pass the examination with strong motivation while recognizing the high possibilities of overcoming the examination.

As a result, such situations may be avoided that a user selects a certifying examination which does not correspond with his/her current ability; he/she makes efforts toward the target which seems to be hardly overcome; and he/she does not recognize the difficulty of the examination until he/she fails the examination. Moreover, the user may take advance measures such as acquiring the basic ability corresponding with the difficulty of the examination.

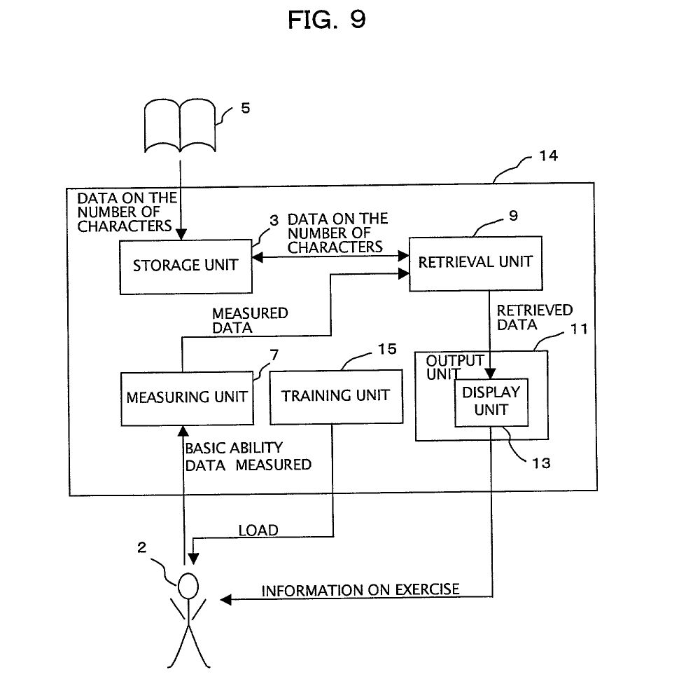

FIG. 9 is a schematic diagram showing an information providing system according to another embodiment of the present invention.

An information providing device 14 is further provided with a training unit 15, which is a different portion from the information providing device shown in FIG. 1. The training unit 15 carries out training for improving a basic ability of the user 2, i.e., an ability to deal with characters.

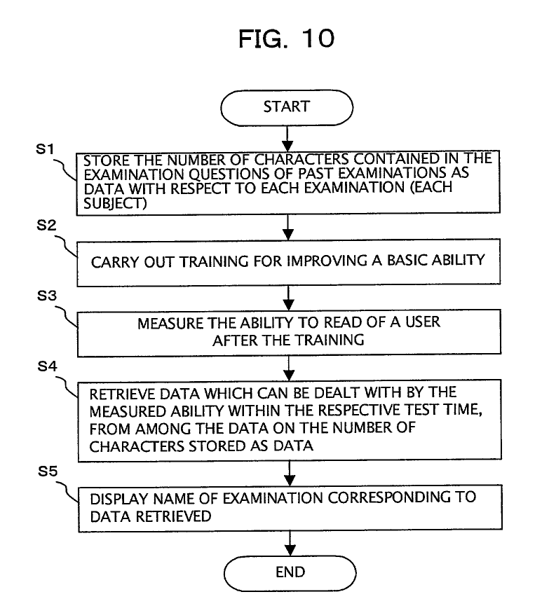

FIG. 10 is a flow chart illustrating steps of operation in the information providing device shown in FIG. 9.

The description of step S1, the operation of which is similar to that of step ST1 shown in FIG. 5, is omitted.

At step S2, the training by the training unit 15 is carried out. The training applies loads to the user 2.

An example of such training methods which have been found as a result of a dedicated study is now described. Sentences are scrolled on the screen at a first speed lightly loading the user 2, who reads sentences while making an effort to keep up with the speed.

The first speed is set on the basis of the data measured before the training being carried out. In other words, the first speed which seems to be difficult to keep up with is set.

Next, the same sentences are scrolled at a second speed heavily loading the user 2. The user 2 reads the sentence while making an effort to keep up with the second speed which seems to be almost impossible to keep up with.

Further, the same sentences are scrolled at an intermediate speed between the first speed and the second speed. The user 2 reads the sentence while making an effort to keep up with the third speed. Although the third speed loads the user 2 heavier than the first speed, it may seem to be easy for the user 2 to follow because he/she has experienced the second speed higher than the present speed.

In short, the time to show the sentences being scrolled to the user 2 is set in a long period of time for the first time, in a short period of time for the second time, and in an intermediate period of time for the third time. The speed is set low, high, and intermediate, respectively.

Needless to say, the training is not limited to the above, and a training for widening the visual field or combination of various trainings may be carried out.

The description of steps S3 to S5, the operations of which are similar to those of steps ST2 to ST4 shown in FIG. 5., is omitted.

The training which applies loads to the user is carried out and the ability improved by the training is measured after the training. The data which can be dealt with within the predetermined time by the user after the training is retrieved and output.

Thus, the name of certifying examination corresponding with the ability of the user improved by the training is presented based on the output result. The user can select the name of certifying examination from among a range of selections broadened by the training, and can make efforts to pass the examination with stronger motivation to acquire a qualification which fulfill his/her desire and satisfaction level.

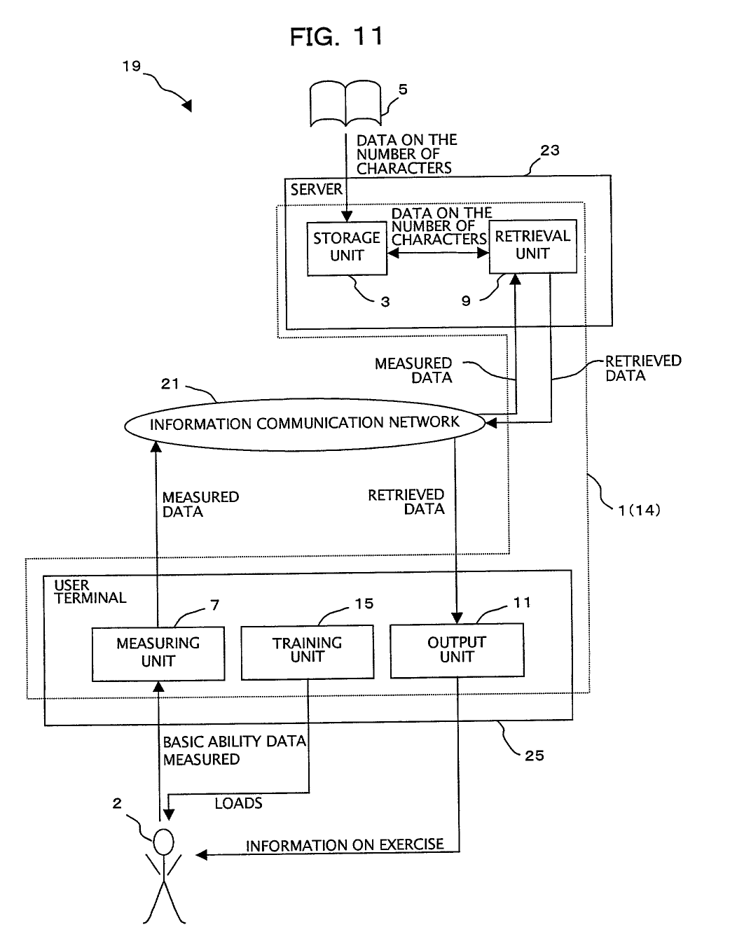

FIG. 11 is a schematic diagram of an information providing system according to an embodiment of the present invention.

In an information providing system 19, an information communication network 21 is utilized. A server 23 and a user terminal 25 are connected to the information communication network 21.

The server 23 is provided with a storage unit 3 and a retrieval unit 9 which are similar to those in the information providing devices 1 and 14 shown in FIGS. 1 and 9. The user terminal 25 is provided with a measuring unit 7 and an output unit 11 which are similar to those in the information providing devices 1 and 14 shown in FIGS. 1 and 9, and further a training unit 15 which is similar to that in the information providing system 14 shown in FIG. 9.

By utilizing the information communication network 21, information on an exercise, which is truly necessary for the user from among a number of exercises having different varieties, is presented. As a result, a need for providing information is increased and a system providing enriched information can be configured as time goes by.

As explained above, the present invention provides the following advantages:

(1) The user is presented the exercise which seems to correspond with his/her ability based on the output result. Accordingly, the user can make efforts to overcome the exercise with strong motivation while recognizing the high possibilities to do so. As a result, such situations may be avoided that a user selects an exercise which does not correspond with his/her current ability; he/she makes efforts toward the target which seems to be hardly overcome; and he/she does not recognize the difficulty of the exercise until he/she fails the exercise. Moreover, the user may take advance measures such as acquiring the basic ability corresponding with the difficulty of the exercise.

(2) The user can visually recognize the presented information. Since the user receives such information through the sense of sight, he/she can understand it accurately, quickly and easily.

(3) The user is presented the information on an exercise as to ability to read. Since exercises often require a person to read sentences containing characters such as examination questions and to answer them, the user can obtain material information on an exercise which is surmised to be possibly overcome by the user from among a plurality of exercises requiring the user to read characters.

(4) The user is presented information on the examination corresponding with the basic ability of the user. Accordingly, the user can make efforts to pass the examination with strong motivation by providing an opportunity to select the examination that he/she possibly overcomes from among various kinds of examinations.

(5) The user is presented information on the preparation course for an examination corresponding with the basic ability of the user. Accordingly, the user can make efforts to study and complete the preparation course with strong motivation to prepare for the examination by providing an opportunity to select the preparation course that he/she possibly overcomes from among various kinds of preparation courses.

(6) The user can avoid such a case where the user borrows a book from a library which can not be read through by the returning limit and returns it without reading through, or a case where the user keeps an overdue book to read through. Consequently, a library is utilized in a manner that the user can finish reading a book and return it within the returning limit, thereby enabling the easy management of the period of lending by the library.

(7) The user is presented information on the exercise corresponding with the ability of the user improved by the training. Accordingly, the user can select the exercise from among a range of selections broadened by the training, and can make efforts to pass the examination with stronger motivation to acquire a qualification which fulfill his/her desire and satisfaction level.

(8) By utilizing the information communication network, information on an exercise, which is truly necessary for the user from among a number of exercises having different varieties, is presented. As a result, a need for providing information is increased and a system providing enriched information can be configured as time goes by.

The preferred embodiments of the present invention have been disclosed by way of example and it will be understood that other modifications may occur to those skilled in the art without departing from the scope and the spirit of the appended claims.

What is claimed is:

1. An information providing device for providing information on an exercise which is surmised to be possibly overcome by a user, from among a plurality of exercises requiring the user to deal with characters within a time predetermined individually, comprising:
a storage means for storing data on the number of characters which is required in each of said exercises;
a measuring means for measuring said predetermined ability to deal with characters of said user;
a retrieval means for retrieving the data which can be dealt with by the basic ability measured by said measuring means within said predetermined time, from among the data stored in said storage means; and
an output means for outputting information on the exercise corresponding to the data retrieved by said retrieval means.

2. The information providing device according to claim 1, wherein said output means is a display means.

3. The information providing device according to claim 1, wherein said basic ability is an ability to read characters.

4. The information providing device according to claim 1, wherein said exercise is an examination held within a examination time.

5. The information providing device according to claim 1, wherein said exercise is a preparation course for an examination which is held no later than the examination date.

6. The information providing device according to claim 3, wherein said exercise is a book having a returning limit lent by a library.

7. The information providing device according to claim 1, further comprising a training means for training said predetermined basic ability to deal with characters of said user:
wherein said measuring means measures said predetermined ability to deal with characters of the user after the training by said training means;
wherein said retrieval means retrieves data which can be dealt with by the basic ability after the training measured by said measuring means within said predetermined time from among the data stored in said storage means; and
wherein said output means outputs information on the exercise corresponding to said data retrieved after the training.

8. An information providing system comprising:
an information communication network;
an information providing device for providing information on an exercise which is surmised to be possibly overcome by a user, from among a plurality of exercises requiring the user to deal with characters within a time predetermined individually, said information providing device being connected to said information communication network; and
a terminal connected to said information network for outputting said information on exercise;
wherein said information providing device comprises:
a storage means for storing data on the number of characters which is required in each of said exercises;
a measuring means for measuring said predetermined ability to deal with characters of said user;
a retrieval means for retrieving the data which can be dealt with by the basic ability measured by said measuring means within said predetermined time, from among the data stored in said storage means; and
an output means for outputting information on the exercise corresponding to the data retrieved by said retrieval means.

9. The information providing system according to claim 8, wherein said output means is a display means.

10. The information providing system according to claim 8, wherein said basic ability is an ability to read characters.

11. The information providing system according to claim 8, wherein said exercise is an examination held within a examination time.

12. The information providing system according to claim 8, wherein said exercise is a preparation course for an examination which is held no later than the examination date.

13. The information providing device according to claim 10, wherein said exercise is a book having a returning limit lent by a library.

14. The information providing system according to claim 8, wherein said information providing device further comprises a training means for training said predetermined basic ability to deal with characters of said user:
wherein said measuring means measures said predetermined ability to deal with characters of the user after the training by said training means;
wherein said retrieval means retrieves data which can be dealt with by the basic ability after the training measured by said measuring means within said predetermined time from among the data stored in said storage means; and
wherein said output means outputs information on the exercise corresponding to said data retrieved after the training.

15. An information providing method for providing information on an exercise which is surmised to be possibly overcome by a user, from among a plurality of exercises requiring the user to deal with characters within the a predetermined individually, comprising the steps of:
storing data on the number of characters which is required in each of said exercises;
measuring said predetermined ability to deal with characters of said user;
retrieving the data which can be dealt with by said measured basic ability within predetermined time, from among said stored data;
outputting information on the exercise corresponding to said retrieved data.

16. The information providing method according to claim 15, further comprising the steps of:
training said predetermined ability to deal with characters of said user;
measuring said predetermined ability to deal with characters of the user measured after said training;
retrieving the data which can be dealt with by said measured basic ability within predetermined time, from among said stored data; and
outputting information on the exercise corresponding to said retrieved data.
